(19) United States
(12) Patent Application Publication
(10) Pub. No.: US 2012/0188456 A1
(43) Pub. Date: Jul. 26, 2012

(54) SINK DEVICE

(75) Inventor: Tatsuo KUROYANAGI, Osaka (JP)

(73) Assignee: FUNAI ELECTRIC CO., LTD., Osaka (JP)

(21) Appl. No.: 13/353,256

(22) Filed: Jan. 18, 2012

(30) Foreign Application Priority Data
Jan. 20, 2011 (JP) 2011-009622

(51) Int. Cl. H04N 5/50; H04N 5/60

(52) U.S. Cl. 348/569; 348/738; 348/731; 348/E05.123; 348/E05.097

(57) ABSTRACT

To provide a sink device that outputs image data and audio data separately when outputting the audio data by using an ARC function, the present invention discloses a sink device that receives image data through an HDMI input port connected to an HDMI cable comprising, an audio input section to receive plural audio data, an HDMI reply section that complies with an ARC function to transmit the received audio data from the HDMI input port, and a control section that receives a selection of the input audio data input to the audio input section and outputs the selected audio data from the audio input section to the HDMI reply section.

### CROSS-REFERENCES TO RELATED APPLICATIONS

The present application is related to the Japanese Patent Application No. 2011-009622, filed Jan. 20, 2011, the entire disclosure of which is expressly incorporated by reference herein.

### BACKGROUND OF THE INVENTION

1. Field of the Invention

The present invention relates to a sink device having an HDMI input port for connecting to an HDMI cable.

2. Description of the Related Art

An HDMI (High-Definition Multimedia Interface) standard is conventionally known as an interface to connect devices. The HDMI is a registered trademark. In the HDMI standard, a source device and a sink device are connected through an HDMI cable. As described in patent documents 1 to 4, the source device transmits uncompressed image data or audio data to the sink device. Note that, a device to transmit the image data and the audio data is called as the source device, and a device to receive the image data and the audio data is called as the sink device.

In an HDMI 1.4 standard, an ARC (Audio Return Channel) function that enables the sink device to transmit the audio data to another device through the HDMI cable is added. In the following explanation, the source device such as a recorder is connected to the sink device without having an HDMI output port such as a display device through a repeater device having both of an HDMI output port and an HDMI input port, as an example. Before the HDMI 1.4 standard, in order to output the audio data from the display device to the repeater device, it was needed to connect an audio output terminal of the display device to an audio input terminal of the repeater device by a cable to transmit the audio data through the cable.

On the other hand, in case the ARC function is adopted as described in the patent document 5, even the sink device without having the HDMI output port can transmit the audio data to the repeater device from the HDMI input port.
Patent document 1: Japanese Patent Application Publication No. 2008-299938
Patent document 2: Japanese Patent Application Publication No. 2007-312182
Patent document 3: Japanese Patent Application Publication No. 2007-213663
Patent document 4: Japanese Patent Application Publication No. 2007-108198
Patent document 5: Japanese Patent Application Publication No. 2010-081434

In the conventional ARC function, the sink device can only output the audio data that is synchronized with the image data. The audio data that is not synchronized with the image data cannot be output. For example, when the sink device outputs the image data concerning television broadcasting by using the ARC function, the sink device can only output both of the image data and the audio data included in the television broadcasting synchronized with each other.

### BRIEF SUMMARY OF THE INVENTION

The present invention discloses the sink device capable of outputting the selected image data and audio data individually by using the ARC function.

The present invention discloses a sink device that receives image data through an HDMI input port connected to an HDMI cable comprising:

an audio input section to receive plural audio data,

an HDMI reply section that complies with an ARC function to transmit the received audio data from the HDMI input port, and

a control section that receives a selection of the input audio data input to the audio input section and outputs the selected audio data from the audio input section to the HDMI reply section.

The invention configured as described above is about the sink device that receives the image data through the HDMI input port connected to the HDMI cable. Here, the sink device receives plural audio data by the audio input section, and then converts the received audio data to a signal with the HDMI standard and transmits the converted signal through the HDMI input port by the HDMI reply section that complies with the ARC function. At the same time, the audio data input to the audio input section is specified by the selection received by the control section, and output to the HDMI receiver section.

Consequently, the audio data to be replied to another device through the HDMI input port by using the ARC function can be arbitrarily selected.

According to the invention configured as described above, the audio data to be replied to another device through the HDMI input port by using the ARC function can be arbitrarily selected.

### BRIEF DESCRIPTION OF THE DRAWINGS

FIG. 1 is a block diagram showing a configuration of an AV (Audio Visual) system 100.

FIG. 2 is a block diagram showing an internal configuration of an amplifier unit 80.

FIG. 3 is a block diagram showing an internal configuration of a display device 70.

FIG. 4 is a block diagram showing a configuration of an HDMI transmitter section and an HDMI receiver section.

FIG. 5 is a flow chart showing a process executed by a microcomputer 75.

FIG. 6 is an example of a selection screen displayed on a display panel 78.

### DETAILED DESCRIPTION OF THE INVENTION

Hereinafter, embodiments of the present invention will be explained in the following order.

1. The first embodiment:

2. Other embodiments:

### 1. The First Embodiment

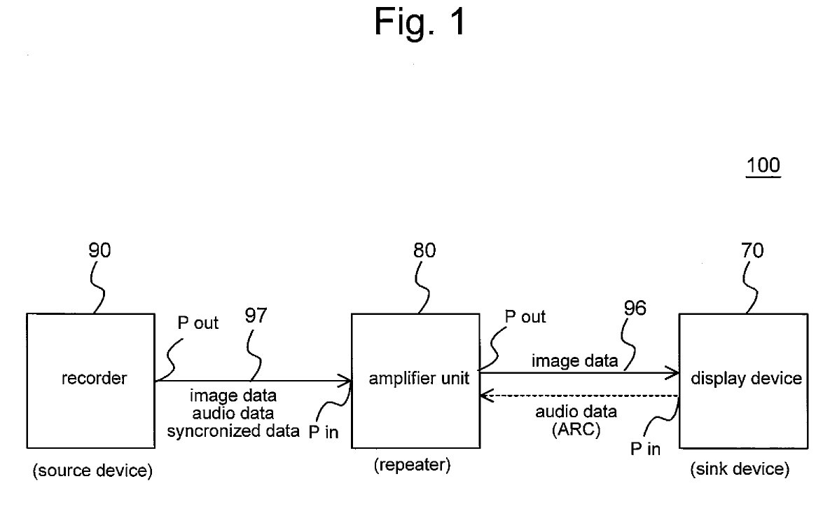

The first embodiment of the present invention concerning a sink device will be explained below with reference to figures. FIG. 1 is a block diagram showing a configuration of an AV (Audio Visual) system 100.

An AV system 100 shown in FIG. 1 is composed of a recorder 90 that functions as a source device, a display device 70 that functions as a sink device, and an amplifier unit 80 that functions as a repeater. Here, the recorder 90, the display device 70 and the amplifier unit 80 comply with an HDMI (High-Definition Multimedia Interface) standard. In addition, each device is connected respectively through HDMI cables 97, 96. In other words, an HDMI output port (P out) of the recorder 90 is connected to an HDMI input port (P in) of the amplifier unit 80 through the HDMI cable 97, and an HDMI output port (P out) of the amplifier unit 80 is connected to an HDMI input port (P in) of the display device 70 through the HDMI cable 96.

Therefore, the audio data is output from the recorder 90 and input to the amplifier unit 80 through the HDMI cable 97. The audio data is output as sound after amplified and processed by the amplifier unit 80. On the other hand, the image data output from the recorder 90 goes through the amplifier unit 80 and the image data is output to the display device 70 through the HDMI cable 96. The image data is output as screen image by the display device 70.

In addition, each device in the present embodiment complies with the HDMI 1.4 standard, and the audio data output from the display device 70 can be transferred to the amplifier unit 80. In other words, the display device 70 and the amplifier unit 80 have an ARC (Audio Return Channel) function defined in the HDMI 1.4 standard. By using the ARC function, the display device 70 can transfer the audio data from the HDMI input port (P in) to the amplifier 80 through the HDMI cable 96.

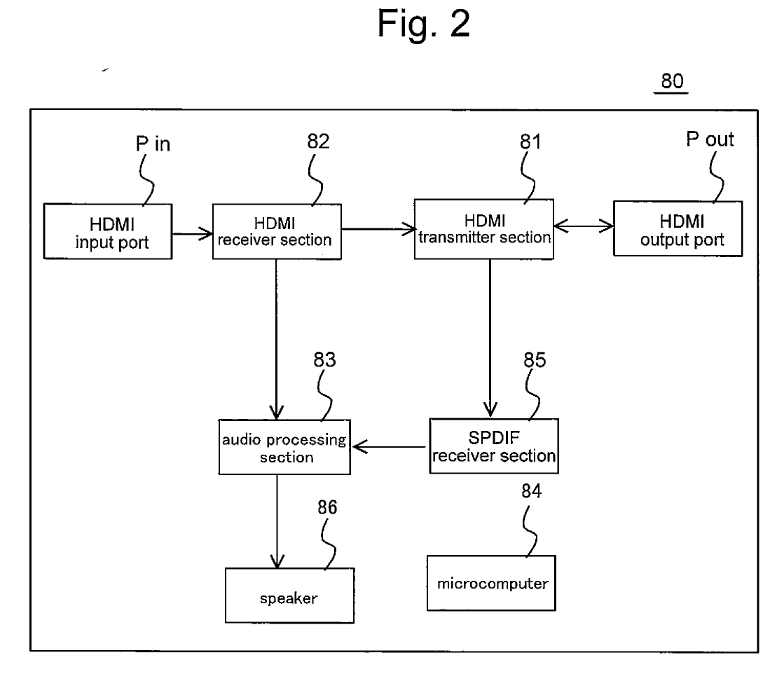

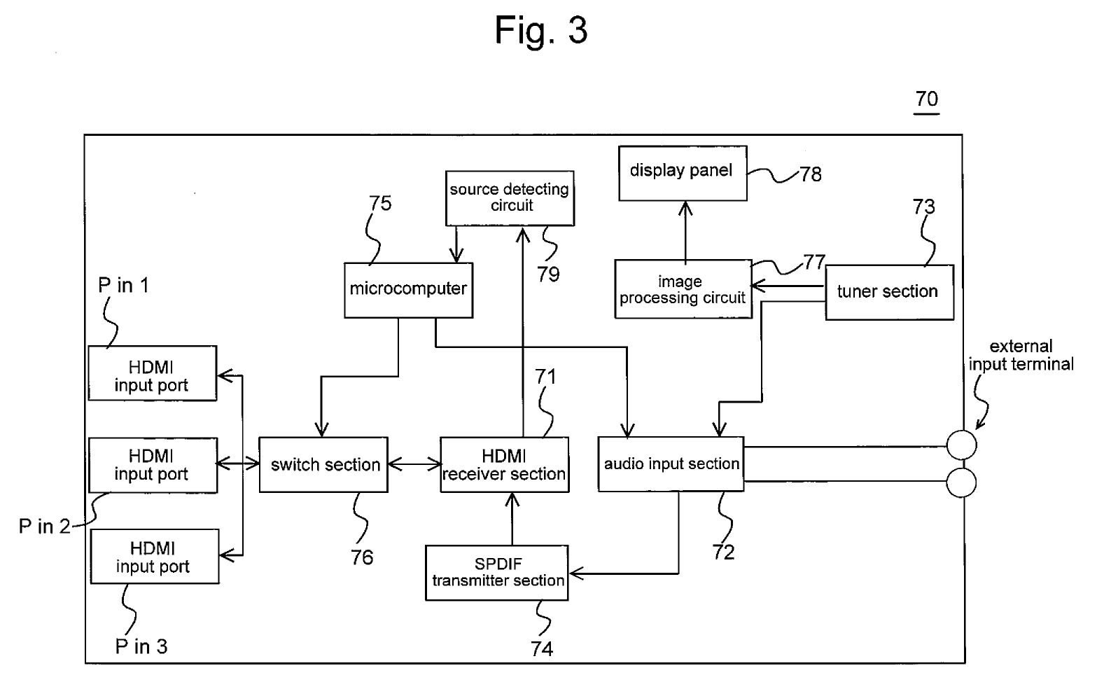

FIG. 2 is a block diagram showing an internal configuration of the amplifier unit 80. FIG. 3 is a block diagram showing an internal configuration of the display device 70. Note that, an explanation about a configuration of the recorder 90 is omitted because the recorder 90 is a source device that complies with the conventional HDMI standard.

As shown in FIG. 2, the amplifier unit 80 has an HDMI transmitter section 81 connected to the HDMI output port (P out) and an HDMI receiver 82 section connected to the HDMI input port (P in). The amplifier unit 80 functions as the repeater device to relay the data transmitted from the source device to the sink device. In other words, the HDMI receiver section 82 is connected to the HDMI transmitter section 81, and the amplifier unit 80 outputs the image data included in an input data from the HDMI output port (P out) connected to the HDMI transmitter section 81. Therefore, the amplifier unit 80 can relay the image data between the recorder 90 and the display device 70. In addition, the amplifier unit 80 complies with the ARC function, and can receive the audio data through the HDMI output port (P out).

The amplifier unit 80 has a sound processing section 83, a microcomputer 84, an SPDIF receiver section 85 and a speaker 86. The microcomputer 84 comprehensively controls the amplifier unit 80. The SPDIF receiver section 85 is connected to a reserve line of the HDMI transmitter section 81 and receives the audio data with an SPDIF (Sony Philips Digital Inter Face) format output from the reserve line. The reserve line is explained later. The sound processing section 83 is connected to the HDMI receiver section 82 and the SPDIF receiver section 85. The sound processing section 83 executes a process such as a digital/analog conversion and an amplification to the audio data with a TMDS format output from the HDMI receiver section 82 or the audio data output from SPDIF receiver section 85, and then outputs the executed audio data to the speaker 86. Therefore, the speaker 86 outputs the sound corresponding to the executed audio data.

As shown in FIG. 3, the display device 70 has an HDMI receiver section 71, an audio input section 72, a tuner section 73, an SPDIF transmitter section 74, a microcomputer 75, a switch section 76, an image processing circuit 77, a display panel 78 and a source detecting circuit 79. The display device 70 functions as the sink device to the recorder 90. Therefore, the display device 70 makes the display panel 78 display a screen image based on the image data received through the HDMI cable 96. In addition, the display device 70 complies with the ARC function, and can output the audio data to the amplifier unit 80 through the reserve line that is included in the HDMI cable 96.

The tuner section 73 extracts the image data and the audio data from television broadcasting signals received by an antenna (not illustrated), and decodes digital data. The audio input section 72 selects one of the audio data decoded by the tuner section 73 or the audio data input from an external input terminal (e.g. composite audio signals, component audio signals) according to control commands transmitted from the microcomputer 75, and then outputs the selected audio data.

The SPDIF transmitter section 74 converts the signal format of the audio data input from the audio input section 72 to comply with the SPDIF format, and then outputs the converted audio data to the HDMI receiver section 71. The SPDIF transmitter section 74 has a conversion circuit (not illustrated) and a transmitter circuit (not illustrated). The conversion circuit converts the input audio data to an SPDIF signal. The transmitter circuit amplifiers the converted SPDIF signal and outputs it to the reserve line of the HDMI receiver section 71.

The HDMI receiver section 71 is connected to the switch section 76. The switch section 76 is also connected to the HDMI input ports (P in 1 to 3). Therefore, the HDMI receiver section 71 receives the image data and its control data through the HDMI cable 96 connected to the HDMI input ports (P in 1 to 3). In addition, the HDMI receiver section 71 complies with the ARC function of the HDMI 1.4 format, and can output the audio data from the HDMI input ports through the reserve line.

Consequently, an HDMI reply section defined in the present invention is achieved by the HDMI receiver section 71 and the SPDIF transmitter section 74.

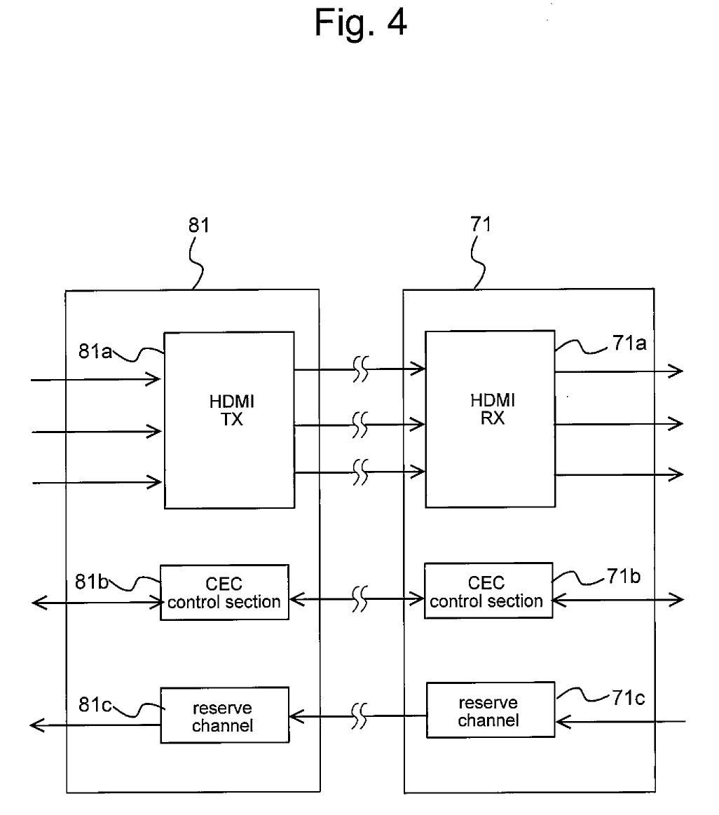

FIG. 4 is a block diagram showing the configuration of the HDMI transmitter section and the HDMI receiver section. The HDMI receiver section 71 has an HDMIRX 71a, a CEC control section 71b and a reserve channel 71c. The HDMIRX 71a receives image data, audio data and synchronized data. The CEC control section 71b sends/receives control commands according to a CEC (Consumer Electronics Control). The reserve channel 71c is a part of the reserve line.

The HDMI transmitter section 81 has an HDMITX 81a, a CEC control section 81b and a reserve channel 81c. The HDMITX 81a transmits image data, audio data and synchronized data. The CEC control section 81b sends/receives control commands according to the CEC. The reserve channel 81c is a part of the reserve line.

In the present embodiment, the reserve line is composed of the reserve channels 71c, 81c, 14 pin of the HDMI input port (P in) and the HDMI output port (P out), and cables to connect both of the 14 pin.

The image data, the audio data and the synchronized data input to the HDMI transmitter section 81 are received by the HDMITX 81a. The HDMITX 81a transmits the image data, the audio data and the synchronized data to the HDMIRX 71a of the HDMI receiver section 71 through each channel of the HDMI cable 96. The control commands according to the CEC are communicated between the CEC control section 71b and the CEC control section 81b through the HDMI cable 96. The reserve channel 71c and the reserve channel 81c are connected to the 14 pin of the HDMI input port (P in) and the HDMI output port (P out), and can be communicated according to the ARC function. In other words, the audio data can be replied from the HDMI receiver section 71 to the HDMI transmitter section 81 by using the reserve line.

As shown in FIG. 3, the switch section 76 is connected to the HDMI receiver section 71 at the input side, and connected to 14 pin of the HDMI input ports (P in 1 to 3) at the output side. The switch section 76 switches the connection to each HDMI input port (P in) based on control from the microcomputer 75. Therefore, the switch section 76 can switch the reserve line to reply the audio data. In the present embodiment, the display device 70 composes three reserve lines for the device connected to each HDMI input ports (P in 1 to 3).

The microcomputer 75 has a CPU (Central Processing Unit), a ROM (Read Only Memory) and a RAM (Random Access Memory), even though these are not illustrated. In the microcomputer 75, the CPU executes comprehensive processes of the display device 70 by using the programs recorded in the ROM. Specifically, by using the program recorded in the ROM, the microcomputer 75 executes a function to display OSD images on the display panel 78, a function to select the audio data to transfer to the amplifier unit 80 by using the ARC function, and a function to switch the HDMI input port (P in) to output the audio data. Consequently, a control section defined in the present invention is achieved by the microcomputer 75.

The source detecting circuit 79 distinguishes a function of the device connected through the HDMI cable. For example, based on a voltage of a signal applied on the reserve line, the source detecting circuit 79 distinguishes whether or not the device connected through the HDMI cable 96 complies with the ARC function.

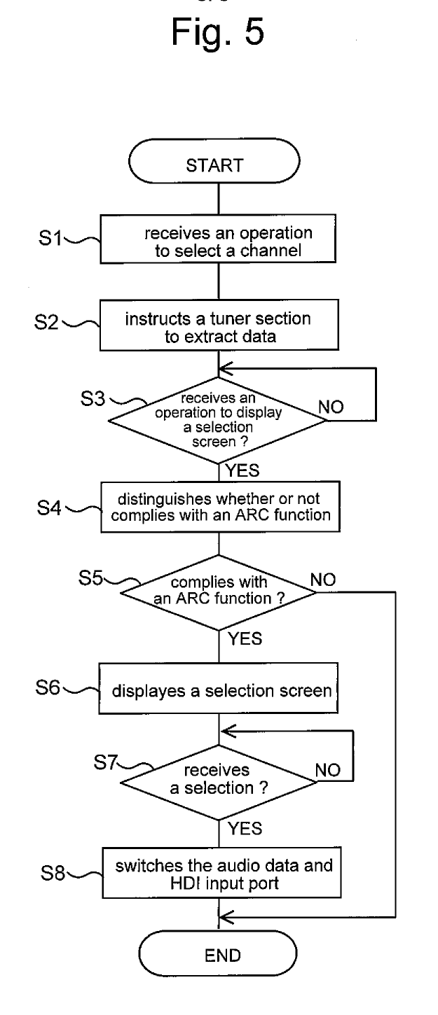

FIG. 5 is a flow chart showing a process executed by the microcomputer 75. A process in FIG. 5 shows how to switch the audio data replied from the display device 70 to the amplifier unit 80 and how to switch the reserve line, with the display device 70 is connected to the amplifier unit 80 as shown in FIG. 1.

If a user operates to select a certain channel by using a remote control device or the like, the microcomputer 75 receives the operation (step S1). The microcomputer 75 instructs the tuner section 73 to extract the image data and the audio data concerning the selected channel (step S2). In this state, the screen image concerning the selected channel is displayed on the display panel 78. In addition, the audio data synchronized with the screen image is input to the amplifier unit 80 through the reserve line of the HDMI cable 96. In case the amplifier unit 80 doesn't comply with the ARC function, even if the audio data concerning the selected channel in the step S1 is output through the HDMI cable 96, the amplifier unit 80 doesn't output the sound based on this audio data.

If the microcomputer 75 receives a user operation to display a selection screen by using the remote control device or the like (step S3: YES), the microcomputer 75 distinguishes whether or not the amplifier unit 80 connected through the HDMI cable 96 complies with the ARC function (step S4). Specifically, the source detecting circuit 79 receives information of the connected device, and the microcomputer 75 distinguishes whether or not the amplifier unit 80 complies with the ARC function based on the received information.

If the amplifier unit 80 doesn't comply with the ARC function (step S5: NO), the microcomputer 75 finishes the process.

If the amplifier unit 80 complies with the ARC function (step S5: YES), the microcomputer 75 displays the selection screen on the display panel 78 by using an OSD function (step S6). Consequently, an OSD display section defined in the present invention is achieved by the microcomputer 75 with the process of the step S6.

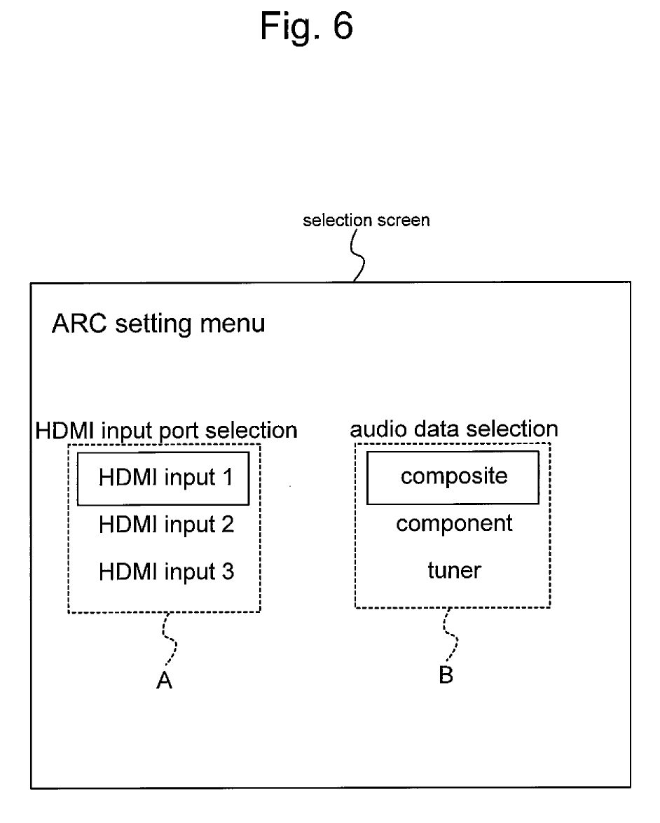

FIG. 6 is an example of the selection screen displayed on the display panel 78. As shown “A” in the left side of FIG. 6, options of the HDMI input port (P in) to which the audio data is output can be displayed. As shown “B” in the right side of FIG. 6, options of the audio data to be replied to the amplifier unit 80 by the ARC function can be displayed. In the present embodiment, because the audio data from the tuner section 73, the composite sound from the external terminal, and the component sound from the external terminal are input to the an audio input section 72, one of them can be selected as an option of the audio data. In the present embodiment, because the display device 70 has three HDMI input ports (P in 1 to 3), one of them can be selected as an option of the HDMI input port (P in). Therefore, the user can select the input audio data and the HDMI input port (P in) to the microcomputer 75 by operating the remote control device or the like to select the option displayed on a slide bar.

If the microcomputer 75 receives a selection of the input audio data and the HDMI input port (P in) through the remote control device (step S7: YES), the microcomputer 75 switches the input audio data and the HDMI input port (P in) (Step S8). In the following explanation, the composite audio data input from the composite terminal and the HDMI input port (P in 3) are selected, as an example. In this case, the microcomputer 75 instructs the audio input section 72 to output the selected composite sound to the SPDIF transmitter section 74, and instructs the switch section 76 to switch to the selected HDMI input port (P in 3).

Consequently, the selected composite sound is output to the amplifier unit 80 through the selected HDMI input port (P in). In the example explained above, the display panel 78 displays the screen image concerning the currently selected channel. However, the amplifier unit 80 connected through the HDMI input port (P in 3) receives the input of the composite sound through the reserve line. Therefore, the amplifier unit 80 outputs the composite sound that is not synchronized with the image displayed on the display device 70. The sink device concerning the first embodiment is explained above.

### 2. Other Embodiments

There are various embodiments of the present invention.

The display device is an example of the sink device to explain an embodiment. Other than the display device, the sink device can be any devices that have the HDMI input port (P in).

The amplifier unit is an example of the repeater device to explain an embodiment. Other than the amplifier unit, the repeater device can be any devices that functions as the repeater.

As explained above, the sink device in the present embodiment receives plural audio data from the audio input section and replies the received audio data to the HDMI input port by the HDMI reply section that complies with the ARC function. At the same time, the audio data input to the audio input section is specified by a selection received by the control section, and the audio data is output to the HDMI receiver section. Consequently, the audio data can be arbitrarily selected when the audio data is replied to another device by using the ARC function.

The sink device can have plural HDMI input ports and the microcomputer can switch the HDMI input port to which the audio data is output by controlling the switch section.

According to the invention configured as described above, the output target of the audio data can be flexibly changed and thus the present invention can be more effectively used.

An OSD screen can be adopted for receiving the operation to switch the audio data output from the audio input section and the operation to switch the HDMI input port.

According to the invention configured as described above, the user can perform the operation concerning the present invention through a visual.

The sink device can have a tuner section to acquire the audio data and output the audio data to the audio input section.

According to the invention configured as described above, even if synchronized image data and audio data concerning television broadcasting are acquired, each data can be output separately.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

1. A sync device that receives image data through an HDMI (High-Definition Multimedia Interface) input port connected to an HDMI cable comprising:
an audio input section to receive plural audio data, an HDMI reply section that complies with an ARC (Audio Return Channel) function to transmit the received audio data from the HDMI input port, and a control section that receives a selection of the input audio data input to the audio input section and outputs the selected audio data from the audio input section to the HDMI reply section.

2. The sink device according to claim 1, further comprising:
plural HDMI input ports, and
a switch section that switches the HDMI input port to which the audio data transmitted from the HDMI reply section is output, wherein
the control section controls the switch section to switch the HDMI input port to which the audio data is output.

3. The sink device according to claim 1, further comprising:
an OSD display section that receives an operation to switch the audio data output from the audio input section and an operation to switch the HDMI input port.

4. The sink device according to claim 2, further comprising:
an OSD display section that receives an operation to switch the audio data output from the audio input section and an operation to switch the HDMI input port.

5. The sink device according to claim 1, further comprising:
a tuner section that extracts image data and audio data from television broadcasting, wherein:
the extracted audio data is output to the audio input section.
